(19) United States
(12) Patent Application Publication
(10) Pub. No.: US 2002/0022496 A1
(43) Pub. Date: Feb. 21, 2002

(54) Flip type mobile telephone

(75) Inventor: Young Ho Park, Kyoungsanam-do (KR)

Correspondence Address: FLESHNER & KIM, LLP, P.O. Box 221200, Chantilly, VA, 20153-1200, US

(73) Assignee: LG Electronics Inc.

(21) Appl. No.: 09/922,783

(22) Filed: Aug. 7, 2001

(30) Foreign Application Priority Data
Aug. 8, 2000 (KR) 22532/2000

(51) Int. Cl. H04M 1/00

(52) U.S. Cl. 455/550; 455/575

(57) ABSTRACT

A flip type mobile telephone is provided with a flip cover attached thereto. The flip type mobile telephone comprises a telephone body provided with a keypad and a hinge shaft provided at an end of the telephone body. A flip cover is hingedly connected to the telephone body through hinge caps inserted onto the hinge shaft. The flip cover covers or exposes the keypad when respectively opened and closed. At least one electromagnet is provided at one side of the telephone body which applies an electromagnetic force toward the flip cover. At least one permanent magnet is provided at a side of the flip cover adjacent to the permanent magnet when the flip cover is closed. The permanent magnet allows opening of the flip cover by applying a magnetic force having a polarity opposite to that of the electromagnet when the electromagnet is energized. Accordingly, the flip cover can be opened by means of the repulsive magnetic force produced between the electromagnet and the permanent magnet when the electromagnet is actuated. The electromagnet can be momentarily energized by pressing the mobile telephone's on/off switch when turning the telephone on for use. Thus, the mobile telephone's keypad is conveniently exposed when the mobile telephone is activated for use.

### BACKGROUND OF THE INVENTION

1. Field of the Invention

The invention relates to a mobile telephone. More particularly, the invention relates to a mobile telephone of a flip type.

2. Background of the Related Art

A mobile telephone is a mobile communication device capable of communicating through a wireless transmission via a relay station. Mobile telephones can be grouped by body type based on how the telephone body is constructed, and in particular, how the telephone keypad is covered. The telephone body types include a bar type cover, a flip type cover, a folder type cover, etc.

The bar type mobile telephone is constructed such that a speaker and microphone are provided within a single case, and a receiver and a transmitter are formed as a unit within the case. Further, the bar type mobile telephone is constructed in such a manner that the keypad is exposed and does not include a removable cover.

The related art flip type mobile telephone of FIGS. 1 and 2 is constructed such that a flip cover 12, by which a keypad 101 can be selectively exposed is attached by a hinge mechanism to a rectangular-shaped telephone body 10 of the mobile telephone. The hinge mechanism of the flip cover 12 is a spring-loaded hinge, which can be resiliently opened and closed according to a pivot angle thereof by the spring, which provides a restoring force upon the flip cover at certain pivot angles. The hinge mechanism is composed of a square-shaped hinge shaft 102 provided on the telephone body 10, a leaf spring (not shown) for elastically supporting the hinge shaft 102 in the telephone body 10, and hinge caps 121 formed on the flip cover 12 to engage the hinge shaft 102. To assemble the hinge mechanism, the flip cover 12 is connected to the telephone body 10 by inserting the hinge shaft 102 into the hinge caps 121.

By way of this hinge and spring combination, when the flip cover 12 is fully closed or fully opened, the leaf spring is in a stable state where it is substantially undeformed and it does not apply a force to the flip cover 12. When the flip cover 12 is between the opened and closed position, it is in an unstable state and at pivot angles where an inner portion of the hinge shaft 102 causes the leaf spring to be elastically deformed. In this unstable state, a force urging the flip cover 12 to return to a stable state (i.e., the opened or closed state) is constantly exerted by the leaf spring on the flip cover 12.

Therefore, according to the related art flip type mobile telephone, the flip cover 12 can be made to “pop” open by raising up the flip cover 12 to a certain angle where the hinge mechanism is rotated slightly past the unstable point, and thereafter the leaf spring automatically forces the flip cover 12 to rotate to the open state. When the user wants to close the flip cover 12, the flip cover 12 can be “popped” closed by pivoting the flip cover 12 toward the closed position past the unstable point whereby the leaf spring automatically applies a force to urge the flip cover into the closed position. That is, according to the related art flip type mobile station mentioned above, the flip cover 12 can be completely opened or closed by any action which partly opens or closes the flip cover 12.

The flip type mobile telephone in accordance with the related art is inconvenient due to the spring force applied to the flip cover. A user generally utilizes only one hand when using the mobile station, which limits a user from applying the relatively strong force required to raise up the flip cover 12 to where the hinge shaft 102 and the hinge cap 121 reach the unstable angle, as described above, in order to open the closed flip cover 12.

### SUMMARY OF THE INVENTION

In order to solve at least the above-mentioned problems and/or disadvantages and to provide at least the advantages described hereinafter in whole or in part, an object of the invention is to provide a flip type mobile telephone wherein the inconvenience of opening or closing the flip cover is reduced.

Another object of the invention is to provide an electromagnetically actuated flip cover, and more particularly a flip type mobile telephone with an electromagnetically actuated flip cover attached thereto.

In order to achieve at least the above objects, a flip type mobile telephone according to the invention includes a telephone body provided with a keypad, a hinge shaft provided at an end of the telephone body, a flip cover hingedly connected to the telephone body through hinge caps inserted onto the hinge shaft configured to cover or expose the keypad by opening or closing the flip cover, at least one electromagnet provided at one side of the telephone body for applying an electromagnetic force to a side of the flip cover, and at least one permanent magnet provided at the side of the flip cover. The electromagnet can effect the opening the flip cover by applying a magnetic force having a polarity opposite to that of the permanent magnet on the flip cover.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements therein:

FIG. 1 is a perspective view showing components of a related art flip type mobile telephone;

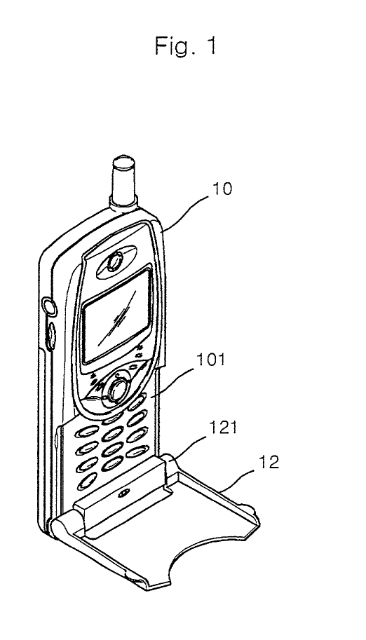

FIG. 2 is an exploded perspective view showing a connecting hinge structure of a telephone body and a flip cover of a related art flip type mobile telephone;

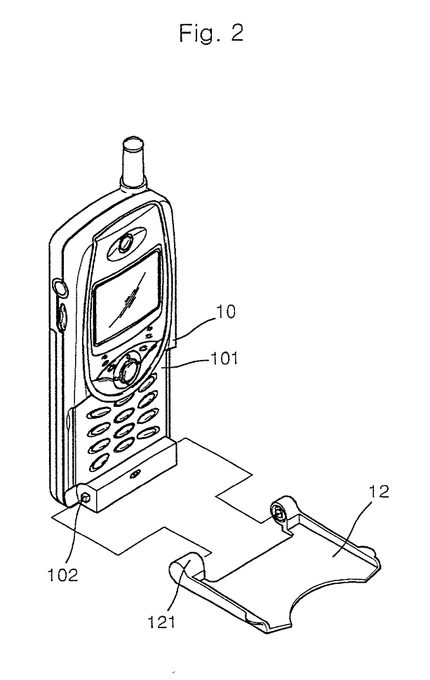

FIG. 3 is a perspective view showing components of a flip type mobile telephone according to an embodiment of the invention; and

FIG. 4 is an exploded perspective view showing a connecting hinge structure of a telephone body and a flip cover according to an embodiment of the invention.

### DETAILED DESCRIPTION OF PREFERRED EMBODIMENTS

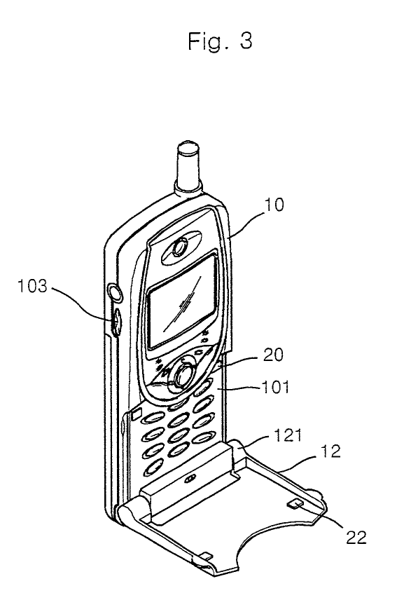

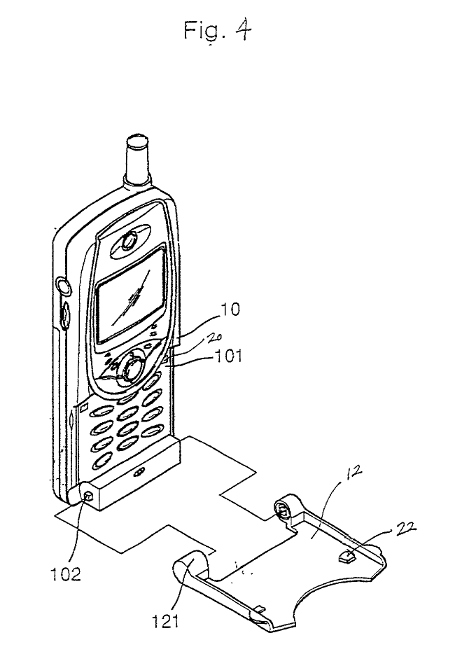

FIGS. 3-4 show a flip type mobile telephone according to an embodiment of the invention. The flip type mobile telephone of FIGS. 3-4 includes a telephone body 10 with a keypad 101 provided therein, and a hinge shaft 102 provided at an end of the telephone body 10. Also provided is a flip cover 12 hingedly connected to the telephone body 10 through hinge caps 121 inserted onto the hinge shaft 102. The flip cover 12 is for covering or exposing the keypad 101 by opening and closing the flip cover 12. To facilitate opening of the flip cover 12, at least one electromagnet 20 is provided at a side of the telephone body 10 for applying an electromagnetic force in a direction of the flip cover 12 when the flip cover 12 is in the closed position, and at least one permanent magnet 22 is provided at a side of the flip cover 12 and is positioned on the flip cover 12 to be proximate to the electromagnet 20 when the flip cover 12 is closed.

The electromagnet 20 can be actuated by electric power supplied from a battery installed in the telephone body 10. The permanent magnet 22 produces magnetic force having a polarity the same as that of the electromagnet 20. This orientation causes the permanent magnet and the electromagnet to repel one another when the electromagnet is energized.

The telephone body 10 may be provided with an actuating switch for operating the electromagnet 20 by momentarily turning on the electric power supplied from the battery to the electromagnet 20. In one embodiment, the operating switch may be included as an additional function to an already existing conventional on/off switch 103 for activating the telephone circuitry in order to ensure the simplicity of the mobile telephone.

When the mobile telephone is not in use and the flip cover 12 is closed, electric power is not supplied to the electromagnet 20. In the closed position, the flip cover 12 is held adjacent to the telephone body 10 by the hinge mechanism. To open the flip cover 12, electric power is momentarily supplied to the electromagnet 20 by the on/off switch 103 which also functions as the on/off switch 103 for the telephone's circuitry, and thus, the electromagnetic force is generated. The electromagnetic 20 produces a strong electromagnetic force having a polarity opposite to the magnetic force of the permanent magnet 22. Consequently, the flip cover 12 is pushed open and pivots on the hinge due to the repulsive force formed between the permanent magnet 22 and the electromagnet 20 when the telephone circuitry is activated for use. When the pivot angle of the flip cover 12 exceeds a predetermined value, the flip cover 12 is resiliently and completely opened by the spring in the hinge mechanism.

The flip cover 12 can be closed by means of the resilient operation of the hinge mechanism in the same manner as the related art flip type mobile telephone. That is, since electric power is supplied to the electromagnet 20 only while the on/off switch 103 is initially pressed down, a repulsive force is not exerted between the electromagnet 20 and the permanent magnet 22 when the flip cover 12 is to be closed. Therefore, the flip cover 12 can be smoothly pivoted shut without resistance from the magnets 20, 22. Thus, the flip cover 12 can be opened by means of the simple operation of pressing down on the on/off switch 103, and closed by the user pushing the flip cover 12 towards the closed position in the conventional manner.

As described above, the flip cover 12 can be opened by means of the repulsive magnetic force produced between an electromagnet 20 and a permanent magnet 22 by the simple operation of pressing down on the telephone's on/off switch 103. Therefore, the telephone can be turned on, and the flip cover opened to expose the keypad by conveniently pressing the telephone on/off switch.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A flip type mobile telephone, comprising:
a telephone body provided with a keypad;
a hinge shaft provided at an end of the telephone body;
a spring disposed within the telephone body and configured to elastically support the hinge;
a flip cover hingedly connected to the telephone body through a plurality of hinge caps inserted onto the hinge shaft, wherein said flip cover is configured to pivot on said hinge shaft, thereby exposing the keypad;
at least one electromagnet provided at one side of the telephone body and configured to apply an electromagnetic force toward the flip cover; and
at least one permanent magnet provided at one side of the flip cover and proximate to the electromagnet when the flip cover is in the closed position.

2. The flip type mobile telephone of claim 1, wherein said electromagnet and said permanent magnet are configured to repel one another when said electromagnet is energized.

3. The flip type mobile telephone of claim 1, further comprising a switch configured to momentarily energize said electromagnet when said mobile telephone is activated.

4. The flip type mobile telephone of claim 1, further comprising a plurality of electromagnets disposed on said telephone body, and a corresponding plurality of permanent magnets disposed on said flip cover, wherein each permanent magnet is located on said flip cover adjacent to a respective electromagnet when said flip cover is in a closed position.

5. The flip type mobile telephone of claim 4, further comprising a switch configured to momentarily energize said plurality of electromagnets when said mobile telephone is activated.

6. The flip type mobile telephone of claim 1, wherein said spring is a leaf spring.

7. The flip type mobile telephone of claim 1, wherein said spring is a coil spring.

8. A flip type mobile telephone, comprising:
a telephone body with a keypad;
a hinge shaft rotatably attached to said telephone body;
a flip cover attached to said hinge shaft and configured to cover said keypad in a closed position and expose said keypad in an open position;
an elastic member configured to bear on said hinge shaft, wherein said elastic member urges said flip cover to an open position when said hinge shaft is rotated past a certain angle;
at least one electromagnet disposed on said telephone body;
at least one permanent magnet disposed on said flip cover, wherein said permanent magnet is configured to be repelled by said electromagnet when said electromagnet is energized; and
a switch configured to energize said electromagnet.

9. The flip type mobile telephone of claim 8, wherein said electromagnet and said permanent magnet cooperate to push said flip cover past said certain angle when said electromagnet is energized.

10. The flip type mobile telephone of claim 8, further comprising a plurality of electromagnets disposed on said telephone body and a corresponding plurality of permanent magnets disposed on said flip cover such that each said permanent magnet is repelled by a respective electromagnet when said plurality of electromagnets are energized.

11. The flip type mobile telephone of claim 8, wherein said switch comprises a momentary switch.

12. The flip type mobile telephone of claim 8, wherein said switch is configured to activate said mobile telephone and simultaneously momentarily energize said electromagnet.

13. The flip type mobile telephone of claim 8, wherein said elastic member is a leaf spring.

14. The flip type mobile telephone of claim 8, wherein said elastic member is a coil spring.

15. A method of opening a flip cover on a mobile telephone, comprising:
rotatably attaching a flip cover to a telephone body with a hinge;
holding said flip cover in a closed position with an elastic member bearing on said hinge;
urging said flip cover into an open position when said flip cover is rotated past a certain angle; and
rotating said flip cover from said closed position past said certain angle by energizing an electromagnet.

16. The method of claim 15, wherein urging said flip cover into an open position comprises applying a force on said flip cover with said elastic member.

17. The method of claim 15, wherein energizing an electromagnet comprises momentarily energizing said electromagnet.

18. The method of claim 15, wherein energizing an electromagnet comprises simultaneously activating a mobile telephone.

19. The method of claim 15, wherein rotating said flip cover from said closed position comprises applying a magnetic force upon a permanent magnet disposed upon said flip cover.

20. A flip type mobile telephone, comprising:
a telephone body with a keypad;
a flip cover elastically rotatably attached to said telephone body and configured to cover said keypad in a closed position and expose said keypad in an open position;
at least one electromagnet disposed on said telephone body;
at least one permanent magnet disposed on said flip cover, wherein said permanent magnet is configured to be repelled by said electromagnet when said electromagnet is energized; and
a switch configured to energize said electromagnet, wherein the repulsion force between the at least one electromagnet and the at least one permanent magnet facilitates the opening of the flip cover.
